(19) United States
(12) Patent Application Publication
(10) Pub. No.: US 2002/0072941 A1
(43) Pub. Date: Jun. 13, 2002

(54) Method and apparatus for processing electronic records for physical transactions

(75) Inventor: Robert P. Lewandowski, Austin, TX (US)

Correspondence Address: Duke W. Yee, Carstens, Yee & Cahoon, LLP, P.O. Box 802334, Dallas, TX, 75380, US

(73) Assignee: IBM Corporation

(21) Appl. No.: 09/731,626

(22) Filed: Dec. 7, 2000

(51) Int. Cl. G06F 17/60

(52) U.S. Cl. 705/7

(57) ABSTRACT

A method and apparatus for processing transactions. In particular, the mechanism of the present invention is used for processing information for physical transactions. A data structure is received at a customer data processing system for a physical transaction entered into by the customer. This information is extracted and used to update records or other information in the customer data processing system. Further, a second data structure is sent to a supplier of an item used in the physical transaction. This data structure is used by the supplier to update information maintained by the supplier about the item. After updating the information, the information is analyzed to generate statistics about physical transactions involving the item.

### BACKGROUND OF THE INVENTION

1. Technical Field

The present invention relates generally to an improved data processing system, and in particular to a method and apparatus for processing data. Still more particularly, the present invention provides a method and apparatus for processing electronic records.

2. Description of Related Art

When a customer goes to a business establishment to obtain services or to purchase items, a transaction occurs. This transaction is a physical transaction in which a customer travels to a business establishment and obtains services or purchases an item at the business establishment. In this transaction, details are typically present about the transaction that the customer desires to obtain. For example, if a customer takes an automobile to a service station for an oil change, the customer may desire to obtain details about the transaction, such as, for example, the amount of oil used, the type of oil used, the mileage, the date of the service, the price for the service, and the name of the service station.

Currently, a customer is required to obtain this information by either asking a representative of the service station for the information or by extracting the information from a physical receipt from the transaction. Such an operation is time-consuming and sometimes frustrating for the customer. In addition to having to actively obtain the information, the customer also is required to enter this information into a database or program used by the customer. For example, the customer may desire to enter the information into an accounting program that maintains records and generates budgets.

Therefore, it would be advantageous to have an improved method and apparatus for processing information relating to a physical transaction.

### SUMMARY OF THE INVENTION

The present invention provides a method and apparatus for processing transactions. In particular, the mechanism of the present invention is used for processing information for physical transactions. A data structure is received at a customer data processing system for a physical transaction entered into by the customer. This information is extracted and used to update records or other information in the customer data processing system. Further, a second data structure is sent to a supplier of an item used in the physical transaction. This data structure is used by the supplier to update information maintained by the supplier about the item. After updating the information, the information is analyzed to generate statistics about physical transactions involving the item.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a diagram of entities involved in processing data for physical transactions in accordance with a preferred embodiment of the present invention;

FIG. 2 is a pictorial representation of a network of data processing systems in which the present invention may be implemented;

FIG. 3 is a block diagram of a data processing system that may be implemented as a server in accordance with a preferred embodiment of the present invention;

FIG. 4 is a block diagram illustrating a data processing system in which the present invention may be implemented;

FIG. 5 is a diagram of a client in the form of a personal digital assistant (PDA) in accordance with a preferred embodiment of the present invention;

FIG. 6 is a block diagram of a PDA in accordance with a preferred embodiment of the present invention;

FIG. 7 is an illustration of an entry for a data structure in accordance with a preferred embodiment of the present invention;

FIG. 8 is a data structure illustrated in accordance with a preferred embodiment of the present invention;

FIG. 9 is a flowchart of a process used for importing data structures in accordance with a preferred embodiment of the present invention;

FIG. 10 is a flowchart of a process used by a business entity for creating data structures in accordance with a preferred embodiment of the present invention; and

FIG. 11 is a flowchart of a process used by a supplier to receive and process data structures in accordance with a preferred embodiment of the present invention.

### DETAILED DESCRIPTION OF THE PREFERRED EMBODIMENT

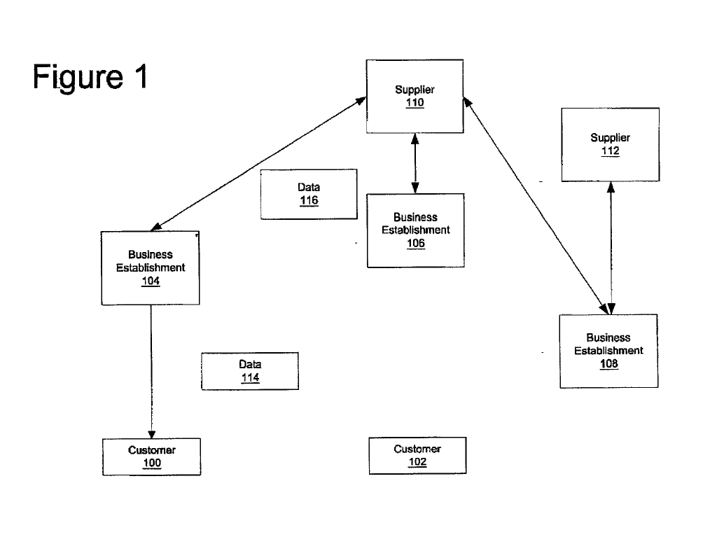

With reference now to the figures, FIG. 1 depicts a diagram of entities involved in processing data for physical transactions in accordance with a preferred embodiment of the present invention. In this example, a customer, such as customer 100 or customer 102 may obtain services or items from various business establishments, such as business establishments 104-108. Items purchased or obtained in connection with a service may originate from a supplier such as supplier 110 or 112. The suppliers may be manufacturers, distributors, or some other entity, which provides items to business establishments 104-108. The items may take various forms depending on the particular implementation. For example, the items may be automotive items, such as oil, tires, body parts, and various accessories.

When a customer, such as customer 100, travels to a business establishment, such as business establishment 104, customer 100 may enter into a physical transaction with business establishment 104. With the example of automotive items, customer 100 may desire details about the transaction for personal records. These details may include, for example, customer name, customer address, mileage of vehicle at service time, vehicle identification, and vehicle year. Also, the description of the item, as well as the price of the item, also are typically desired by customer 100. In this example, a standardized record, such as data structure 114, is created by business establishment 104 and sent to customer 100. Data structure 114 is sent electronically. This data structure may be sent in a number of different ways, such as, for example, as an electronic mail message attachment to the address for customer 100 or through a wireless data link to a personal digital assistant (PDA) carried by customer 100.

Additionally, a data structure 116 also may be transmitted to supplier 110 in response to the same physical transaction. Data structure 116 may be a duplicate of data structure 114 or may be modified to protect the privacy of customer 100. The modification may take out personal identification information such as the customer name and address. Fields within data structures 114 and 116 may include mandatory fields that are found in all data structures used to enable different data processing system systems and programs to receive and import the information form these data structures. The data structures are also referred to as electronic records. If more than one item is present from more than one supplier the a data structure may be sent to each supplier.

With this information a customer may update personal records, such as a database containing a budget or a set of maintenance records. For example, with an oil change, a data structure may be sent to the customer with details about the oil change. A budget database for the customer may be updated automatically upon receiving the data structure.

A supplier receiving the data structure may update its records using the data structure and track the purchase and use of items by different customers. This information may be analyzed to produce statistics on the use of items as well as demand for items in different geographic regions.

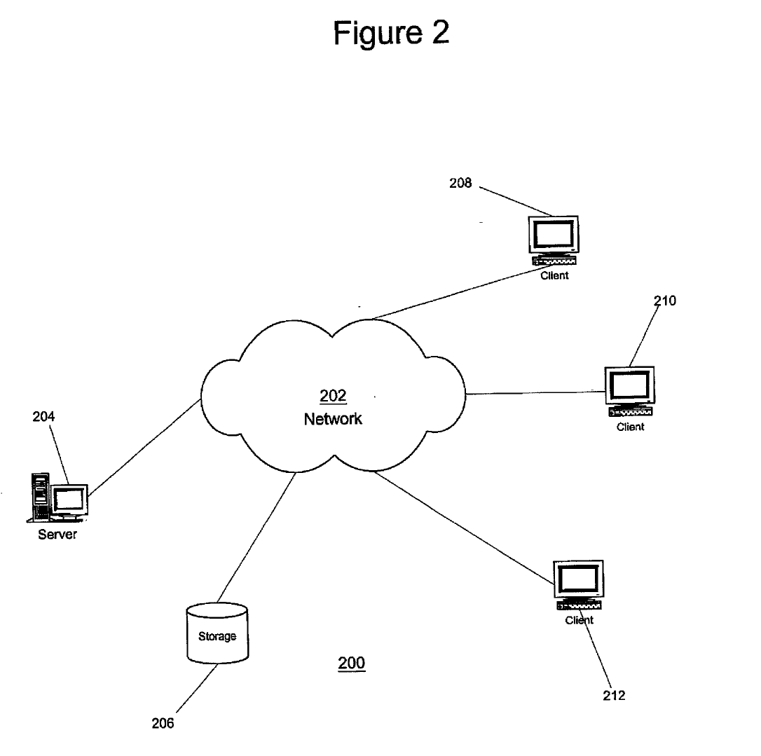

Turning next to FIG. 2, Network data processing system 200 is a network of computers in which the present invention may be implemented. Network data processing system 200 contains a network 202, which is the medium used to provide communications links between various devices and computers connected together within network data processing system 200. Network 202 may include connections, such as wire, wireless communication links, or fiber optic cables. Data processing system 200 may be used to interconnect different entities, such as customers, business establishments, and suppliers.

In the depicted example, a server 204 is connected to network 202 along with storage unit 206. In addition, clients 208, 210, and 212 also are connected to network 202. These clients 208, 210, and 212 may be, for example, personal computers or network computers. In the depicted example, server 204 provides data, such as boot files, operating system images, and applications to clients 208-212. Clients 208, 210, and 212 are clients to server 204. Network data processing system 200 may include additional servers, clients, and other devices not shown. In these examples, server 204 may be located at a business establishment to generate electronic records while clients 208-212 may be located at a customer location or at a supplier location.

In the depicted example, network data processing system 200 is the Internet with network 202 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for the present invention.

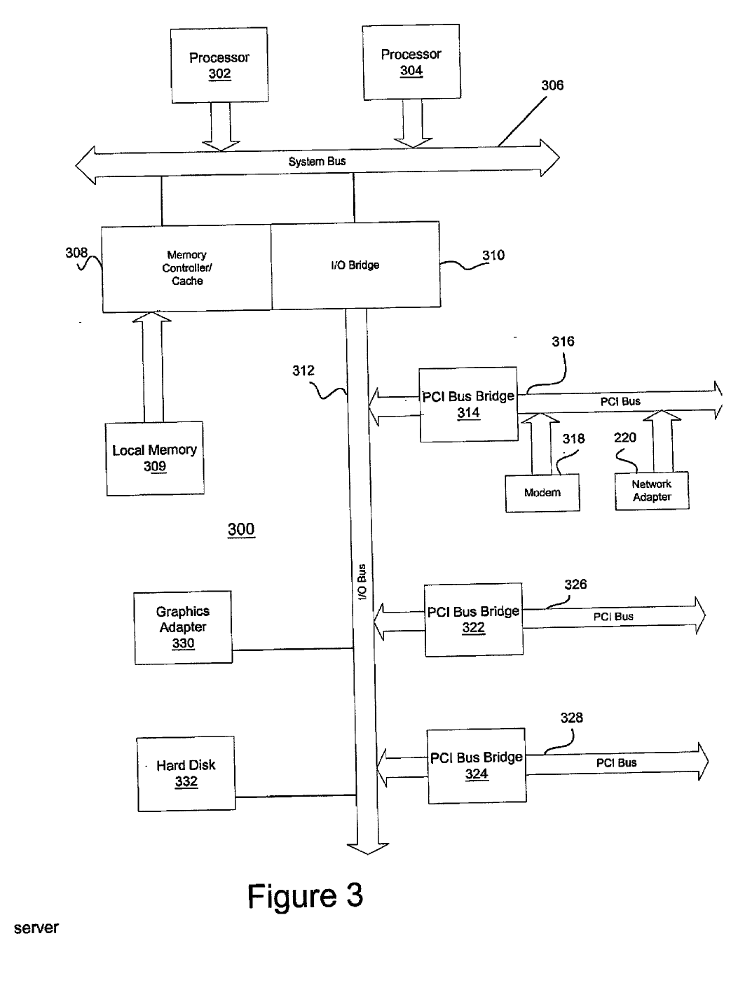

Referring to FIG. 3, a block diagram of a data processing system that may be implemented as a server, such as server 204 in FIG. 2, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI bus 316. Typical PCI bus implementations will support four PCI expansion slots or add-in connectors. Communications links to network computers 208-212 in FIG. 2 may be provided through modem 318 and network adapter 320 connected to PCI local bus 316 through add-in boards.

Additional PCI bus bridges 322 and 324 provide interfaces for additional PCI buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM RISC/System 6000 system, a product of International Business Machines Corporation in Armonk, N.Y., running the Advanced Interactive Executive (AIX) operating system.

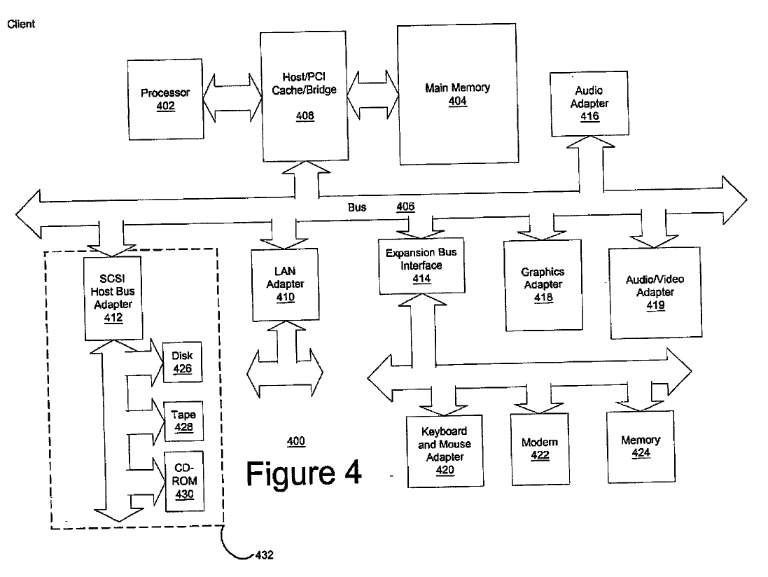

With reference now to FIG. 4, a block diagram illustrating a data processing system is depicted in which the present invention may be implemented. Data processing system 400 is an example of a client computer. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424. Small computer system interface (SCSI) host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows 2000, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4. Also, the processes of the present invention may be applied to a multiprocessor data processing system.

As another example, data processing system 400 may be a stand-alone system configured to be bootable without relying on some type of network communication interface, whether or not data processing system 400 comprises some type of network communication interface. As a further example, data processing system 400 may be a Personal Digital Assistant (PDA) device, which is configured with ROM and/or flash ROM in order to provide non-volatile memory for storing operating system files and/or user-generated data.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

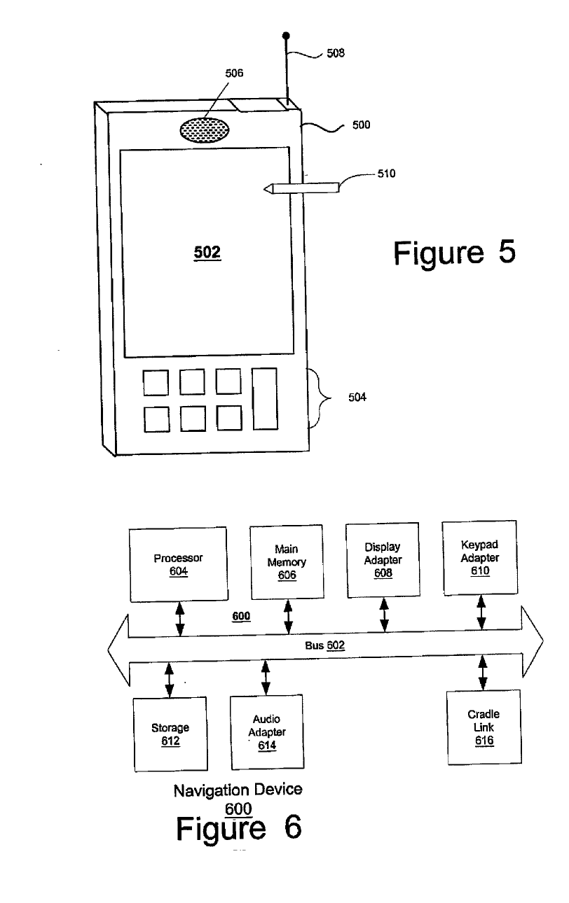

With reference now to FIG. 5, a diagram of a client in the form of a personal digital assistant (PDA) is depicted in accordance with a preferred embodiment of the present invention. PDA 500 includes a display 502 for presenting textual and graphical information. Display 502 may be a known display device, such as a liquid crystal display (LCD) device. The display may be used to present a map or directions, calendar information, a telephone directory, or an electronic mail message. In these examples, screen 502 may receive user input using an input device such as, for example, stylus 510.

PDA 500 may also include keypad 504, speaker 506, and antenna 508. Keypad 504 may be used to enter user input in addition to using screen 502. Speaker 506 provides a mechanism for audio output, such as presentation of an audio file. Antenna 508 provides a mechanism used in establishing a wireless communications link between PDA 500 and a network, such as network 202 in FIG. 2.

PDA 500 also preferably includes a graphical user interface that may be implemented by means of systems software residing in computer readable media in operation within PDA 500.

Turning now to FIG. 6, a block diagram of a PDA is shown in accordance with a preferred embodiment of the present invention. PDA 600 is an example of a PDA, such as PDA 500 in FIG. 5, in which code or instructions implementing the processes of the present invention may be located. PDA 600 includes a bus 602 to which processor 604 and main memory 606 are connected. Display adapter 608, keypad adapter 610, storage 612, and audio adapter 614 also are connected to bus 602. Cradle link 616 provides a mechanism to connect PDA 600 to a cradle used in synchronizing data in PDA 600 with another data processing system. Further, display adapter 608 also includes a mechanism to receive user input from a stylus when a touch screen display is employed.

An operating system runs on processor 604 and is used to coordinate and provide control of various components within PDA 600 in FIG. 6. The operating system may be, for example, a commercially available operating system such as Windows CE, which is available from Microsoft Corporation. Instructions for the operating system and applications or programs are located on storage devices, such as storage 612, and may be loaded into main memory 606 for execution by processor 604.

Those of ordinary skill in the art will appreciate that the hardware in FIG. 6 may vary depending on the implementation. Other internal hardware or peripheral devices, such as flash ROM (or equivalent nonvolatile memory) or optical disk drives and the like, may be used in addition to or in place of the hardware depicted in FIG. 6.

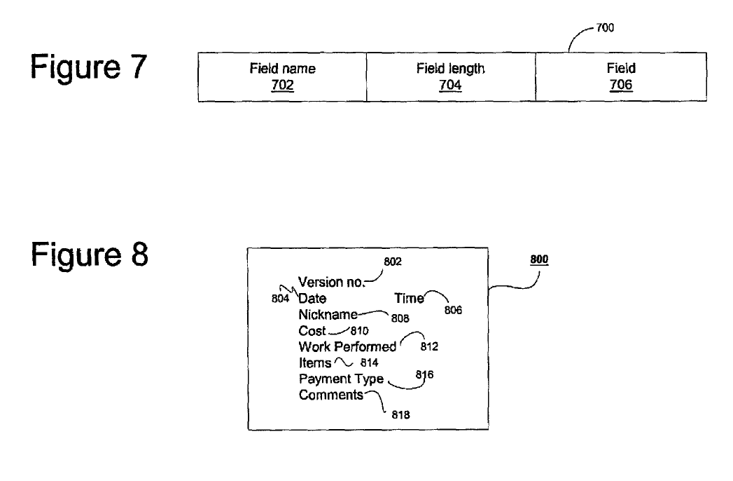

Turning next to FIG. 7, an illustration of an entry for a data structure is depicted in accordance with a preferred embodiment of the present invention. Entry 700 includes a field name 702, a field length 704, and a field 706. Field name 702 is used to identify the field, while field 704 defines the length of field 706. Various information may be placed in an entry, such as entry 700. For example, customer name, a vehicle name, mileage, price, and item description may be placed into field 706 in entry 700.

With reference next to FIG. 8, a data structure is illustrated in accordance with a preferred embodiment of the present invention. In this example, data structure 800 contains a version number 802, date 804, time 806, a nickname 808, a cost 810, work performed 812, items 814, payment type 816, and comments 818.

In these examples, version number 802, date 804, and time 806 are contained within a header in data structure 800. Based on the version number, an identification of the size and type of data may be made such that the use of field name and field length definitions, such as those used in entry 700 in FIG. 7 are unnecessary. Nickname 804 may be used to identify a particular vehicle for a user. Cost 810, work performed 812, and items 814 identify information about the service itself. Payment type 816 indicates how the customer paid for the service.

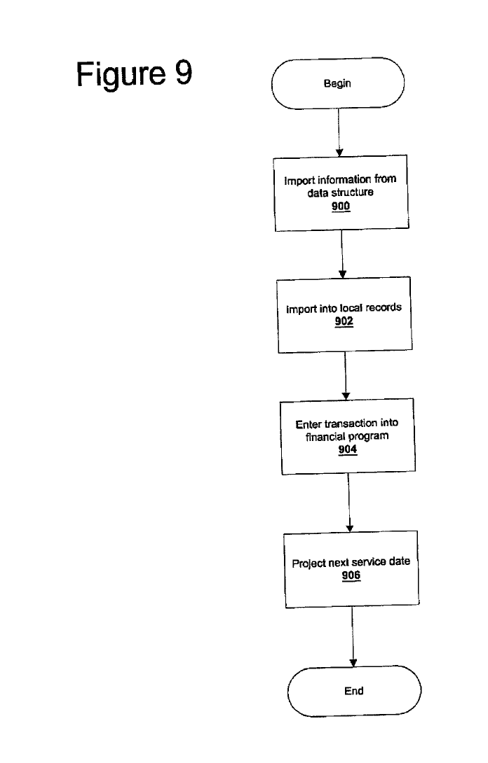

Referring to FIG. 9, a flowchart of a process used for importing data structures is depicted in accordance with a preferred embodiment of the present invention. The process illustrated in FIG. 9 may be implemented in a client data processing system such as data processing system 400 in FIG. 4 or PDA 600 in FIG. 6. This process illustrates an exemplary use by customer of a data structure in accordance with a preferred embodiment of the present invention. In this example, the data structure represents a transaction involving service for a vehicle.

The process begins by receiving the data structure (step 900). This data structure may be received by the customer in a number of different ways. For example, the data structure may be sent to the customer in an electronic mail message. Alternatively, the data structure may be transferred to the customer PDA through a wireless connection prior to the customer leaving the business establishment.

Next, the data structure is imported for use locally into the local records (step 902). The importing of the data structure may be performed using a process or program, which recognizes the data structure and the fields within the data structure. With a standardized data structure, a common process or program may be used by customers and suppliers. After this step occurs, the transaction is entered into a financial program (step 904). The entry of the transaction into a financial program in this example involves placing the information into the database associated with the financial program. The process importing the information also may place the information within the financial program. In this example, the process recognizes fields within the data structure used by the financial program and formats that information for placement into the financial program. Finally, the next service date is projected (step 906). In addition, the information from the data structure may be used by another program to project another service date for the vehicle.

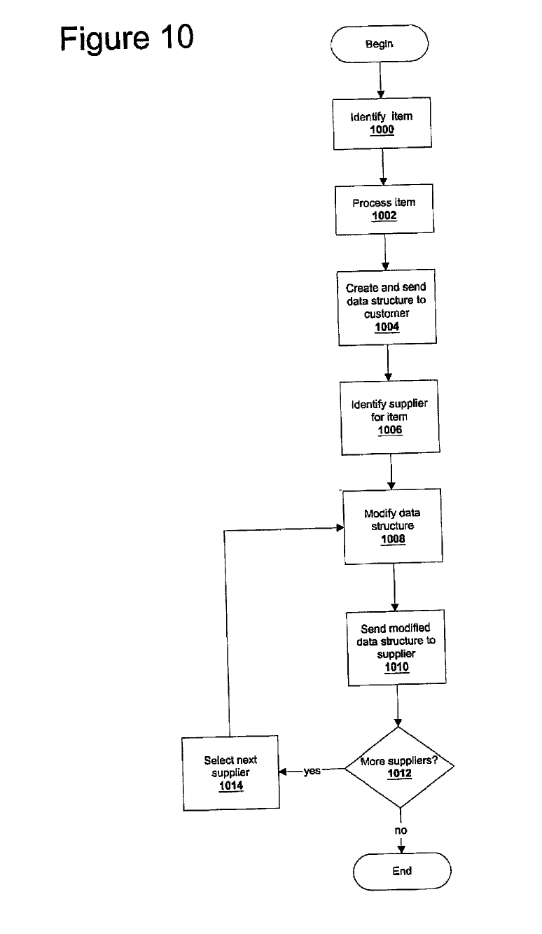

Turning now to FIG. 10, a flowchart of a process used by a business entity for creating data structures is depicted in accordance with a preferred embodiment of the present invention. The process illustrated in FIG. 10 may be implemented in a data processing system at a business entity. This process may be implemented in a data processing system, such as data processing system 300 in FIG. 3.

The process begins by receiving the service item (step 1000). The item is one involved in the transaction with the customer. The item may be selected from an inventory database of items available at the business establishment. This item may be received as a selection of the item for sale or use in providing service for a customer. After the item is identified, it is processed (step 1002). The processing of the item in this example involves removing it from the inventory database. Next, a data structure is created and sent to the customer (step 1004). This data structure may be, for example, data structure 800 in FIG. 8. The information within the fields of the data structure may be retrieved from an inventory database or entered by a user in completing the physical transaction with the customer.

After this step occurs, the manufacturer for the item is identified (step 1006). After the aforementioned manufacturer is identified, the data structure is modified (step 1008). Step 1008 is an optional step in which information may be removed from the data structure to protect the privacy of the customer. For example, the name and other personal information about the customer may be removed from the data structure.

Next, the modified data structure is sent to the supplier (step 1010). A determination is made as to whether more manufacturers are present that require information (step 1012). The physical transaction may involve multiple items supplied by different suppliers. If more suppliers are not present, the process terminates. If, however, more suppliers are needed, the next supplier is selected (step 1014). After the next supplier is selected, the process returns to step 1008, where the data structure is modified.

The supplier data sent in the process described in FIG. 10 may be sent on a regular basis, such as daily or monthly instead of after each transaction.

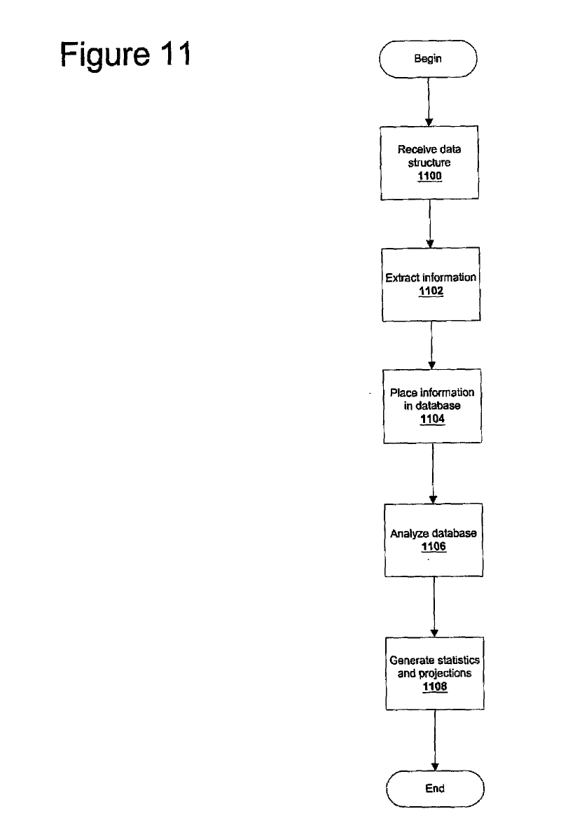

Turning now to FIG. 11, a flowchart of a process used by a supplier to receive and process data structures is depicted in accordance with a preferred embodiment of the present invention. This process is used by a supplier, such as a manufacturer or distributor of items to analyze the use and purchase of items.

The process begins by receiving a data structure (step 1100). This data structure in these examples are received from a business entity, but also may be received from customers. Information is extracted from the data structure (step 1102). The information is then placed in a database for analysis (step 1104). This database may contain information for a particular type of item or for all items supplied by the supplier. The database is then analyzed (step 1106). This analysis may include statistical analysis of the information for various factors, such as what items are purchased more frequently during certain periods of time or in selected geographic regions. Additionally, depending on the information included in the data structure, an analysis of demographics of customers purchasing the items also may be made. Based on this analysis, statistics and projections are generated (step 1108) with the process terminating thereafter. These statistics and projections may be used by the supplier to make business decisions such as, for example, how much of an item to keep in inventory and whether to keep certain items in inventory during certain periods of time.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, items may encompass automobiles in addition to parts for automobiles and may extend to non-automotive items, such as perishable goods and building supplies. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing a physical transaction, the method comprising the data processing system implemented steps of:
receiving data structures containing information about the physical transactions from a plurality entities performing the physical transactions, wherein the data structures include information about the physical transactions;
updating a database of physical transactions in response to receiving the data structures to form an updated database; and
analyzing the update database to generate statistics about the physical transactions.

2. The method of claim 1 further comprising:
analyzing the statistics to generate projections about future physical transactions.

3. The method of claim 1, wherein the physical transactions involved automotive services.

4. The method of claim 3, wherein the information includes an item in the physical transaction.

5. The method of claim 4, wherein the information includes an identification of a vehicle in the transaction.

6. The method of claim 3, wherein the automotive services is at least one of an oil change, a tune up, body work on a vehicle, or an alignment.

7. The method of claim 1, wherein the plurality of entities are located in different geographic locations.

8. The method of claim 1, wherein the data structures are received using one of electronic mail messages, a floppy disc, or CD-ROM.

9. A method in a data processing system for processing a transaction involving a set of items, the method comprising the data processing system implemented steps of:
identifying a supplier for each item within the set of items in the transaction;
generating an electronic record of the transaction for the set of items; and
transmitting the electronic record to each identified supplier.

10. The method of claim 9, wherein the generating step comprises:
creating an electronic record containing only information about items within the set of items for a single identified supplier, wherein each identified supplier receives a different electronic record.

11. The method of claim 9, wherein the supplier is a supplier of automotive items.

12. The method of claim 9 further comprising:
transmitting the electronic record to a customer of the transaction.

13. The method of claim 12, wherein the electronic record is transmitted to the customer using at least one of an electronic mail message and a wireless communications link.

14. The method of claim 9, wherein the transaction involves providing an automotive service for a customer.

15. A method in a data processing system for processing records for physical transactions, the method comprising the data processing system implemented steps of:
receiving a data structure containing information for a physical transaction for the customer; and
updating a set of records within the data processing system using the information in the data structure.

16. The method of claim 15, wherein the updating step comprising:
identifying at least one program within the data processing system requiring information from the data structure;
extracting the information from the data structure; and
placing the information into a format used by the at least one program.

17. The method of clam 15 further comprising:
projecting future physical transactions using the information.

18. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive data structures containing information about the physical transactions from a plurality entities performing the physical transactions in which wherein the data structures include information about the physical transactions, update a database of physical transactions in response to receiving the data structures to form an updated database, and analyze the update database to generate statistics about the physical transactions.

19. The data processing system of claim 18, wherein the bus system is a single bus.

20. The data processing system of claim 18, wherein the bus system includes a primary bus and a secondary bus.

21. The data processing system of claim 18, wherein the processing unit includes a plurality of processors.

22. The data processing system of claim 18, wherein the communications unit is one of a modem and Ethernet adapter.

23. A data processing system comprising:
a bus system;
a communications unit connected to the bus system;
a memory connected to the bus system, wherein the memory includes as set of instructions; and
a processing unit connected to the bus system, wherein the processing unit executes the set of instructions to identify a supplier for each item within a set of items in a transaction, generate an electronic record of the transaction for the set of items, and transmit the electronic record to each identified supplier.

24. A data processing system for processing a physical transaction, the data processing system comprising:
receiving means for receiving data structures containing information about the physical transactions from a plurality entities performing the physical transactions, wherein the data structures include information about the physical transactions;
updating means for updating a database of physical transactions in response to receiving the data structures to form an updated database; and
analyzing means for analyzing the update database to generate statistics about the physical transactions.

25. The data processing system of claim 24 wherein the analyzing means is a first analyzing means further comprising:
second analyzing means for analyzing the statistics to generate projections about future physical transactions.

26. The data processing system of claim 24, wherein the physical transactions involved automotive services.

27. The data processing system of claim 26, wherein the information includes an item in the physical transaction.

28. The data processing system of claim 27, wherein the information includes an identification of a vehicle in the transaction.

29. The data processing system of claim 26, wherein the automotive services is at least one of an oil change, a tune up, body work on a vehicle, or an alignment.

30. The data processing system of claim 24, wherein the plurality of entities are located in different geographic locations.

31. The data processing system of claim 24, wherein the data structures are received using one of electronic mail messages, a floppy disc, or CD-ROM.

32. A data processing system for processing a transaction involving a set of items, the data processing system comprising:
identifying means for identifying a supplier for each item within the set of items in the transaction;
generating means for generating an electronic record of the transaction for the set of items; and
transmitting means for transmitting the electronic record to each identified supplier.

33. The data processing system of claim 32, wherein the generating step comprises:
creating means for creating an electronic record containing only information about items within the set of items for a single identified supplier, wherein each identified supplier receives a different electronic record.

34. The data processing system of claim 32, wherein the supplier is a supplier of automotive items.

35. The data processing system of claim 32 further comprising:
transmitting means for transmitting the electronic record to a customer of the transaction.

36. The data processing system of claim 32, wherein the electronic record is transmitted to the customer using at least one of an electronic mail message and a wireless communications link.

37. The data processing system of claim 32, wherein the transaction involves providing an automotive service for a customer.

38. A data processing system for processing records for physical transactions, the data processing system comprising:
receiving means for receiving a data structure containing information for a physical transaction for the customer; and
updating means for updating a set of records within the data processing system using the information in the data structure.

39. The data processing system of claim 38, wherein the updating means comprising:
identifying means for identifying at least one program within the data processing system requiring information from the data structure;
extracting means for extracting the information from the data structure; and
placing means for placing the information into a format used by the at least one program.

40. The data processing system of claim 38 further comprising:
projecting means for projecting future physical transactions using the information.

41. A computer program product in a computer readable medium for use in processing a physical transaction, the computer program product comprising:
first instructions for receiving data structures containing information about the physical transactions from a plurality entities performing the physical transactions, wherein the data structures include information about the physical transactions;
second instructions for updating a database of physical transactions in response to receiving the data structures to form an updated database; and
third instructions for analyzing the update database to generate statistics about the physical transactions.

42. A computer program product in a computer readable medium for use in processing a transaction involving a set of items, the computer program product comprising:
first instructions for identifying a supplier for each item within the set of items in the transaction;
second instructions for generating an electronic record of the transaction for the set of items; and
third instructions for transmitting the electronic record to each identified supplier.

43. A computer program product in a computer readable medium for use in processing records for physical transactions, the computer program product comprising:
first instructions for receiving a data structure containing information for a physical transaction for the customer; and
second instructions for updating a set of records within the data processing system using the information in the data structure.
